(19) United States
(12) Patent Application Publication
(10) Pub. No.: US 2004/0189769 A1
(43) Pub. Date: Sep. 30, 2004

(54) Methods, systems, and devices for drying ink deposited upon a medium

(75) Inventors: Raymond D. Wilbur, San Jose, CA (US); Joseph C. Lathbury, Middlesex (GB); Yann Ischi, Sausalito, CA (US); Robert C. Hockett, Aptos, CA (US); Daniel T. Nguyen, San Jose, CA (US)

Correspondence Address: WORKMAN, NYDEGGER & SEELEY, ATTORNEY AT LAW, 1000 EAGLE GATE TOWER, 60 EAST SOUTH TEMPLE, SALT LAKE CITY, UT, 84111, US

(73) Assignee: Oce Display Graphics Systems, Inc.

(21) Appl. No.: 10/408,832

(22) Filed: Mar. 31, 2003

(51) Int. Cl. B41J 2/01

(52) U.S. Cl. 347/102

(57) ABSTRACT

A printing system for drying ink deposited upon a printable medium. The system including at least one print head for directing ink onto the medium as the print head moves over the printable medium. Moving with the print head is at least one halogen lamp that generates electromagnetic radiation having a sufficient wavelength to penetrate the ink. The at least one halogen lamp may irradiate the printable medium and/or the platen, with one or both of the printable medium and the platen aiding with drying the ink deposited upon the printable medium.

### BACKGROUND OF THE INVENTION

1. The Field of the Invention

The present invention relates to systems, methods, and devices for drying ink deposited upon a medium. More particularly, the present invention relates to systems, methods, and devices for drying ink deposited upon a print medium with a rapidly activated and deactivated radiation source that is attached to a moving carriage.

2. The Relevant Technology

A variety of different printing devices have been developed to spray, jet, or deposit ink upon a medium. Each device has a different configuration based upon the particular ink deposited. Some printing devices deposit ultraviolet (UV) curable inks that harden or cure upon exposure to UV radiation to cure or harden the ink. Other inks, such as solvent-type inks and aqueous-based inks, dry as a solvent or water within the ink evaporates. Although a number of techniques are available to evaporate the solvent or water from the ink, each has its limitations and problems.

One technique to dry solvent or aqueous-based ink is to dry after all the ink is deposited upon the medium. An existing device capable of drying such inks elevates the temperature of the air within a print zone of the printer device, i.e., area of the printer device within which the print heads move as they spray, jet, or deposit ink upon a medium. This type of system, unfortunately, decreases the reliability of the nozzles that jet or spray the ink upon the medium. The decrease in nozzle dependability occurs because the increased temperature of the air within the print zone dries the pre-deposited ink upon a faceplate of the print head. Since solvent and aqueous-based inks dry through evaporation, increasing the air temperature within the print zone causes the pre-sprayed or jetted ink to dry at the nozzles. The dried ink clogs the nozzles of the print head and prevents accurate jetting or spraying of the ink. In addition to reducing the dependability of the nozzles, the heating effect may not be quickly or rapidly turned “on” or “off.” These systems require a relatively long warm-up period before the printing device is prepared to deposit ink upon a medium. Similarly, the system has a long cool-down period before the system stops applying heat energy to the deposited ink and the medium.

Another manner to dry deposited solvent or aqueous-based ink is to heat the medium. One manner to achieve this is by heating a platen of the printer device. This type of device uses a heating assembly, such as coil heater, attached underneath the platen. The heater or heating element increases the platen temperature to a sufficiently high temperature that the solvent or water within the deposited ink evaporates as the medium moves over the platen. This heater or heating element increases the overall dimensions of the printer device and is expensive, thereby increasing the cost of the printer device.

In addition to increasing the cost of the device, the heating effect provided by the heater platen is difficult to control and has long warm-up and cool-down periods. These systems require a relatively long warm-up period before the printing device may deposit ink upon a medium. The heater must be turned ON for a long enough period so that the platen stores the heat energy sufficiently to dry the deposited ink. Similarly, the system has a long cool-down period following the deposit and drying processes because the platen has to release the heat energy, which may take a long period.

The platen heater devices also may burn, melt, warp, or otherwise damage a temperature sensitive medium, such as a commonly used medium having a sandwich of a backing layer, an adhesive layer deposited upon the backing layer, and a finish layer upon which the ink is deposited. Heat energy applied to the backing layer by the platen must pass through the backing layer, the adhesive layer, and the finish layer before it heats the deposited ink. Since each layer of the medium acts as an insulator, the platen temperature must be high enough so the heat energy reaching the deposited ink is sufficient to dry the ink. A temperature sufficient to dry the ink may be sufficient to damage the medium.

Damage to the medium may also occur in the event that the progression of the medium over the platen is stopped. As mentioned above, the platen must be maintained at a sufficiently high temperature to effectively dry the deposited ink. Stopping of the medium upon the platen may result in excessive heat being applied to the medium and damage to the medium. Hot spot heating of the medium may also occur because of variations in the materials forming the medium or deficiencies in the material or tolerances associated with the platen.

Another technique to dry deposited ink is to blow hot air over the surface of the medium to dry the deposited ink. As with other existing techniques, this technique elevates the temperature of the air within the print zone of the printer device to dry the ink. These systems have nozzle reliability problems because of the drying of pre-sprayed or pre-jetted ink upon the faceplate of the printer head. Additionally, a significant cost is associated with hot air drying device, as well as the need for increased space required for the blowers, fans, and ductwork to pass the hot air to the print zone. Further, the heating effect in these systems may not be quickly or rapidly turned “on” or “off.” Instead, these types of system require a relatively long warm-up period before the printing device may deposit ink upon a medium and a long cool-down period following a deposit process.

It would be desirable to provide systems, methods, and devices that facilitate drying of solvent and aqueous-based inks upon a medium, while maintaining print quality, and limiting the potential for damaging the medium during the printing process.

### BRIEF SUMMARY OF THE INVENTION

The present invention generally relates to methods, systems, and devices for depositing ink upon a printable medium and subsequently drying the deposited ink in a manner where the heating effect may be rapidly turned “on” or “off.” Embodiments of the present invention facilitate drying of the deposited ink without substantially raising the air temperature within the print zone. Applying directional electromagnetic radiation to the deposited ink to dry the ink, rather than generally increasing the temperature of the air within the print zone may achieve this. The directed electromagnetic radiation may be rapidly activated and deactivated with the associated heating and cooling of the printer device.

According to one aspect of the present invention, a printing system is provided that includes a printer device. The printer device is configured to deposit ink upon a printable medium and to dry the deposited ink using directed electromagnetic radiation. The printer device includes a print carriage that traverses a track, with the track being configured to allow the print carriage to be selectively located beyond a peripheral edge of the medium. By so doing, the printer device prevents damage to the printable medium as the printer head carriage stops, passes over the printable medium, and reverses direction to perform another pass over the printable medium. Additionally, the printer carriage may be located off the printable medium during maintenance or problem resolution that may occur during the printing process.

According to another aspect of the present invention, the printer carriage is adapted with one or more heater assemblies. Each heater assembly may be adapted to C generate electromagnetic radiation that is directed toward the printable medium and the ink deposited thereupon. Upon activating a heater assembly, delivery of heat energy to the deposited ink occurs rapidly after activation. Similarly, deactivating of the heater assembly rapidly eliminates the delivery of heat energy to the deposited ink. This provides rapid control of the timing and quantity of heat energy directed to the deposited ink and limits the potential for medium damage.

The spectrum of electromagnetic radiation generated by each heater assembly may include a peak at the short wavelengths of the infrared spectrum. With electromagnetic radiation having such a wavelength peak, the radiation may penetrate multiple layers of deposited ink to dry the ink. The radiation may also be incident upon the printable medium. By elevating the temperature of the printable medium, an embodiment of the present invention provides additional drying effect to the ink from the printable medium.

According to another aspect of one embodiment of the present invention, the printer device may be used with a wide range of printable media because the radiation applied to the deposited ink continually moves from one ink drop to the next. This is in contrast to other devices where the heat is static, such as with the case of heated air-drying devices and heated platen type device. Through moving the radiation source continually, the deposited ink is quickly dried and the medium is not sufficiently heated to burn, melt, or warp, depending upon the particular material forming the media.

In still another embodiment of the present invention, the radiation may be incident upon a platen upon which the printable medium traverses. Through uniformly irradiating the platen through the printable medium, the platen may become a thermal mass that may release its heat energy to the printable medium and hence aid with drying the ink deposited upon the printable medium.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of an exemplary printer device of a printing system in accordance with one embodiment of the present invention;

FIG. 2 is a partial perspective view of an exemplary printer carriage and track of the printer device of FIG. 1 in accordance with one embodiment of the present invention;

FIG. 3 is a partial a side view of the exemplary printer carriage of FIG. 2;

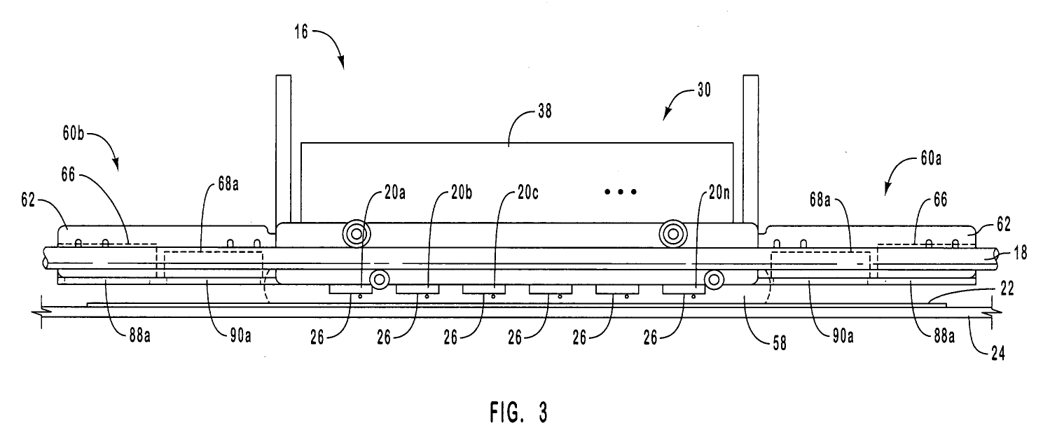

FIG. 4 is an exploded perspective view of one embodiment of a connecting bracket and a mounting bracket of a heater assembly of the printer device of FIG. 1;

FIG. 5 is a partial plan view of the printer carriage of the printer device of FIG. 1;

FIG. 6 is an exploded perspective view of one embodiment of a heating mechanism on the heater assembly of the printer device of FIG. 1;

FIG. 7 is a partial side view of the printer device of FIG. 1 with the inclusion of one embodiment of a secondary heating source in accordance with another aspect of one embodiment of the present invention.

### DETAILED DESCRIPTION OF THE PREFERRED EMBODIMENTS

The present invention generally relates to methods, systems, and devices for depositing and drying ink upon a medium. The illustrative methods, systems, and devices facilitate drying of deposited ink, maintaining print quality, limiting the potential for medium damage during the printing process, while reducing the potential for medium damage during turn around of the print carriage.

The following discussion of the present invention will be directed to large format printing systems and devices. One skilled in the art, however, may appreciate that the teachings of the present invention may be used with other types of printing systems or devices, ranging from small home use printers or systems to large commercial printers or systems.

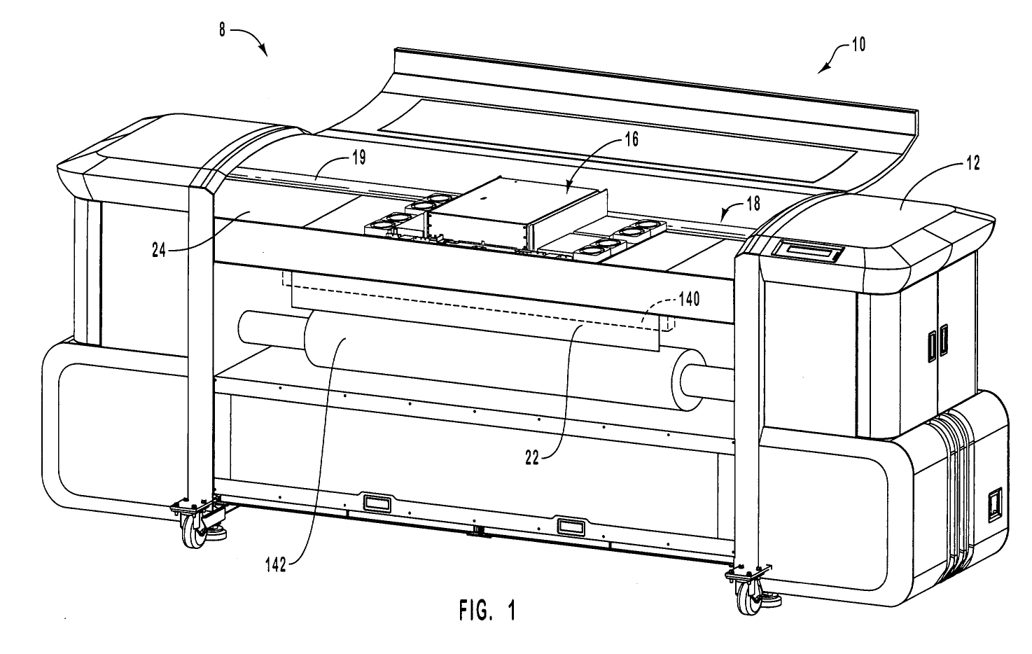

FIG. 1 depicts is an exemplary configuration of one possible printing system of the present invention. The printing system 8 is capable of delivering ink, whether the ink is a radiation curable ink, such as, but not limited to, a solvent-based ink, aqueous ink, or any other type of ink or fluid capable of being sprayed or jetted onto a printable medium 22. Printable medium 22 may be, but is not limited to, a cellulose medium, a plastic medium, a metallic medium, a synthetic medium, a silk medium, a canvas medium, a paper medium, a textile medium, a medium formed from one or more naturally occurring substances, a medium formed from one or more synthetic substances, combinations thereof, or other medium that is capable of receiving ink delivered from print heads during a printing process. Although not depicted in FIG. 1, one skilled in the art will appreciate that printing system 8 may optionally communicate with an ink reservoir located external and remote from a printer device 10 of printing system 8.

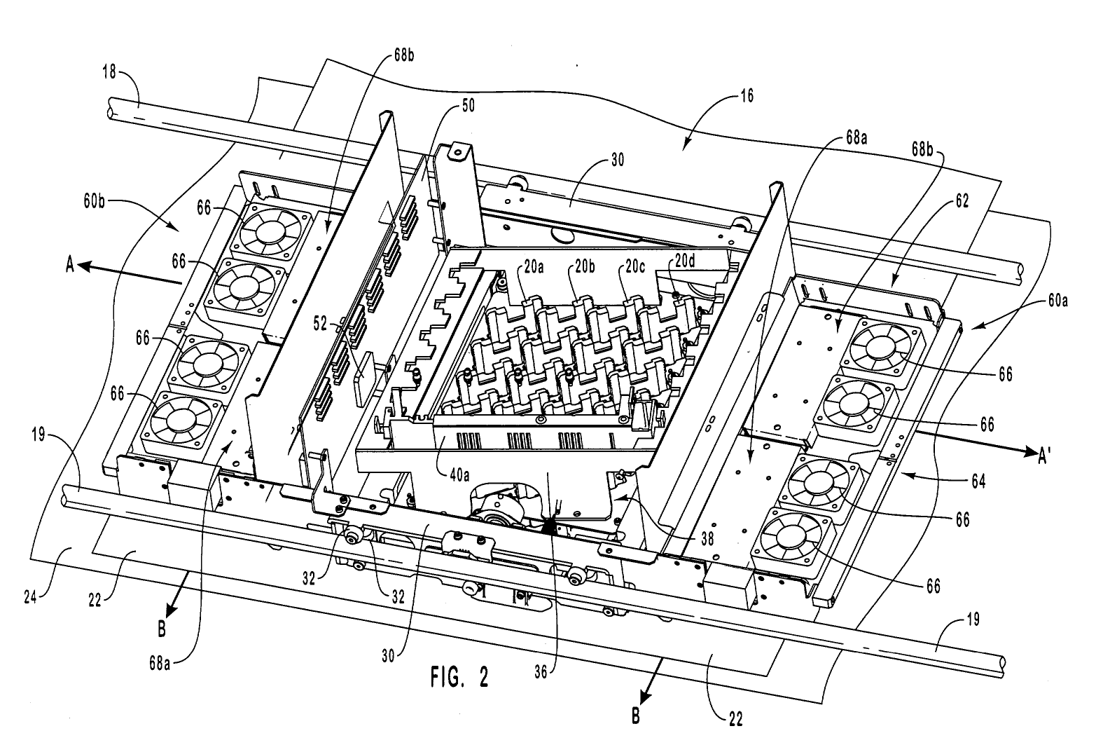

Printer device 10 of printing system 8 includes a housing 12 that retains various components and control mechanisms of printer device 10, only some of which will be described herein for ease of explanation of the present invention. Other components will be understood by those skilled in the art. Disposed within housing 12 is a printer carriage 16 that is movably mounted to a track 18 having one or more rails, only rail 19 being shown in FIG. 1. The printer carriage 16 moves back and forth along track 18 to allow one or more print heads 20a-20n (see FIG. 2) mounted to printer carriage 16 to deliver ink to a printable medium 22 as the medium moves over a platen 24. Relative movement of printer carriage 16 along track 18 may occur through various driving mechanisms. For instance, the driving mechanism may include, but not limited to, hydraulic or pneumatic driver mechanisms, mechanical driver mechanisms, chain, belt, or cable and driven sprocket mechanisms, combinations thereof, or other types of driving mechanism that are capable of performing the function of moving the printer head carriage along a track.

FIG. 2 illustrates a partially assembled printer head carriage 16 that is adapted to move over printable medium 22, in the direction of Arrows A and A′, as printable medium 22 traverses platen 24, in the direction of Arrows B. Printer head carriage 16 may move substantially completely over the complete width and length of printable medium 22. To aid with this, track 18 has sufficient length that print head carriage 16 may move completely off printable medium 22 or beyond a peripheral edge of printable medium 22 when turning around, i.e., stopping and reversing direction, after a pass over printable medium 22. This design of printer device 10 prevents damage to printable medium 22 as printer carriage 16 stops follow a printing pass over printable medium 22 and reverses direction to perform another printing pass over printable medium 22. Additionally, this configuration of track 18 enables printer head carriage 16 to be positioned off printable medium 22 during maintenance, heating, and/or cooling of the heating assemblies of printer head carriage 16. Again, this prevents excessive heating of printable medium 22 and the deposited ink that may result in medium damage or poor image quality.

In one embodiment, printer head carriage 16 includes a support structure 30 that slidably cooperates with track 18. As illustrated, one or more wheels 32 coupled to support structure 30 aid with moving printer carriage 16 along track 18 under the influence of the driving mechanism (not shown). Although reference is made to the use of wheels 32, it may be understood that printer carriage 16 may includes various other mechanisms that are capable of performing the function of aiding to move printer carriage 16 along track 18.

The support structure 30 may support print heads 20a-20n and optionally one or more reservoirs 40a-40n that store ink to be delivered from print heads 20a-20n to printable medium 22.

Also mounted to support structure 30 is a control board 50 that provides an interface between print heads 20a-20n and the control systems and circuitry (not show) of printer device 10 (FIG. 1) and/or printing system 8 of the present invention. In one configuration, control board 50 connects to each print head 20a-20n through a ribbon wire or other electrical connection mechanism (not shown) that allows signals to be transmitted from control board 50 to initiate the delivery of ink from each print head 20a-20n.

In the illustrated configuration, two heater assemblies 60a and 60b are mounted to support structure 30. Heater assembly 60a is disposed upon one side of support structure 30 and heater assembly 60b is disposed upon another side of support structure 30. In other configurations, print head carriage 16 may include a single or a plurality of heater assemblies mounted to support structure 30. Although reference is made to mounting a heater assembly to a support structure, one skilled in the art will understand that one or more heater assemblies may be integrally formed with the support structure.

In one possible embodiment, heater assembly 60a includes one or more heating mechanisms 68a and 68b. Each heating mechanism 68a and 68b generates the desired electromagnetic radiation to dry the ink deposited upon printable medium 22 as print head carriage 16 traverses printable medium 22. The generated electromagnetic radiation has a wide wavelength spectrum of visible light, with the wavelength spectrum of the radiation having a high peak at or near to the shorter wavelengths of the IR spectrum.

Radiation having these characteristics may be used to dry the deposited ink, heat printable medium 22, and/or heat platen 24. Heating mechanism 68a and 68b may be rapidly activated and deactivated to deliver the radiation, i.e., turning heating assemblies “on” to deliver radiation or “off” to stop delivering radiation. This adds controllability to intensity and power output of the radiation delivered to printable medium 22. Rapid delivery of the desired amount of radiation decreases the printing process time for printing and image by decreasing the warm-up time for printing device 10. Similarly, rapid stopping of radiation delivery prevent over-irradiation and resultant damage to printable medium 22.

Heating mechanisms 68a and 68b are adapted to dry the ink deposited upon printable medium 22. Heating mechanisms 68a and 68b may rapidly deliver electromagnetic radiation towards printable medium 22 to dry the deposited ink when heating mechanisms 68a and 68b are activated, i.e., turned on. The present invention provides a fast response time between activating one or both of heating mechanisms 68a and 68b and delivery of sufficient electromagnetic radiation, such as infrared (IR) radiation, to dry the deposited ink. This quick response reduces the start-up time needed before printer device 10 may deposit ink upon printable medium 22. This reduces the time needed to print an image upon printable medium 22. Additionally, the quick response limits the potential for damage to printable medium 22 because of the ability to rapidly activate, turn on, and deactivate, turn off, the electromagnetic radiation delivered to printable medium 22.

The electromagnetic radiation generated by one embodiment of heating mechanisms 68a and 68b may penetrate the deposited ink to partially dry the ink and heat printable medium 22. A short wavelength of IR spectrum may be sufficient to penetrate the deposited ink and heat printable medium 22. Heating printable medium 22 aids with drying the ink because the deposited ink receives direct heating from heating mechanisms 68a and 68b and secondary heating from printable medium 22. In addition to heating printable medium 22, the electromagnetic radiation may heat platen 24. Heat from platen 24 may also aid with drying the ink deposited upon printable medium 22. Therefore, ink deposited upon printable medium 22 may be heated directly by the electromagnetic radiation provided by (i) heating mechanisms 68a and 68b, (ii) printable medium 22, and/or (iii) platen 24.

In more detail, one or both of heating mechanisms 68a and 68b generate a quantity of photons that are directed to the deposited ink, printable medium 22, and/or platen 24. The generated photons have sufficient energy levels to penetrate the deposited ink, whether a single layer of ink or multiple layers of ink and cause drying of the ink. The photons may also have sufficient energy levels to be incident upon printable medium 22 and/or platen 24 to cause heating of the same. Using photons with sufficient energy levels to penetrate through one or more layer of ink enables the present invention to directionally heat, dry, or cure deposited ink without intentionally elevating the air temperature within a print zone of printer device 10 that would result in drying of pre-sprayed or pre-jetted ink upon faceplates of print head 22a-22n. Additionally, using directed electromagnetic radiation enables printer device 10 to heat printable medium 22 before the ink is deposited thereupon. Elevating printable medium 22 temperature aids with drying of the deposited ink.

Using directed electromagnetic radiation also reduces the potential of medium burns during drying of the deposited ink. Unlike other printer devices that use static heating of the printable medium and/or the deposited ink, the present invention uses a moving heat technique where the heat source, i.e., heating mechanisms 68a and 68b, moves over printable medium 22. The deposited ink droplets quickly dry as the primary radiation source moves continually over the ink droplets and printable medium 22. This movement eliminates the potential for printable medium 22 burning, melting, or warping because insufficient electromagnetic radiation is incident upon any given portion of printable medium 22 to cause burning, melting, or warping. This allows printer device 10 and printing system 8 to use a variety of different media, whether or not such media is temperature sensitive.

Furthermore, using moving directed electromagnetic radiation to dry the deposited ink reduces the potential for creating hot spots upon platen 24. As discussed above, medium burns may occur when hot spots occur on the platen or the printable medium remains at a particular position on the platen to create a burn. The present invention overcomes these problems by evenly irradiating platen 24 as heating mechanisms 68a and 68b traverse platen 24. The platen 24 is not directly heated, such as with a separate heating system or device, but rather is heated indirectly through propagation of photons toward platen 24 through the deposited ink and printable medium 24. Uniformly or evenly irradiating platen 24 causes platen 24 to become a thermal mass that may radiate heat energy uniformly toward medium 22 as medium 22 passes over platen 24 without hot spots forming upon platen 24. The platen 24 may optionally aid with drying of the ink deposited upon medium 22.

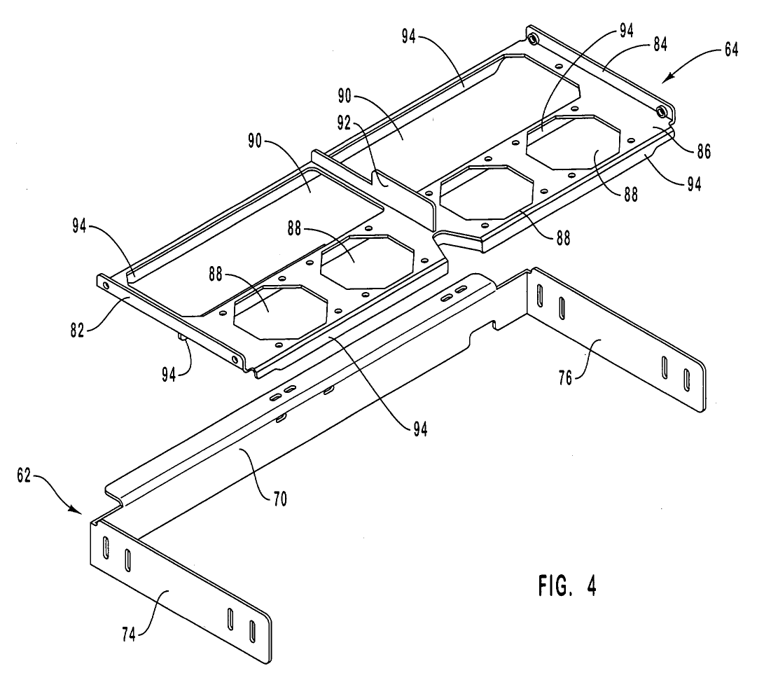

With continued reference to FIG. 4, in addition to heating mechanisms 68a and 68b, each heater assembly 60a may include one or more fans 66. The fans 66 are adapted to circulate the air within printer device 10 to aid with maintaining the temperature within the print zone below a threshold level above which pre-deposited ink dries at faceplates 26 of print heads 20a-20n. Each fan 66 may have various configurations as known to one skilled in the art. For instance, each fan may be an air-bearing fan, a sleeve-bearing fan, an oil-bearing fan, a brushless fan, a ball-bearing fan, or the like. Additionally, fan 66 may be either a constant speed fan or a variable speed fan. Although the above are provided as illustrative examples of various fans, one skilled in the art in light of the teaching contained herein may identify various other fans capable of performing the desired function.

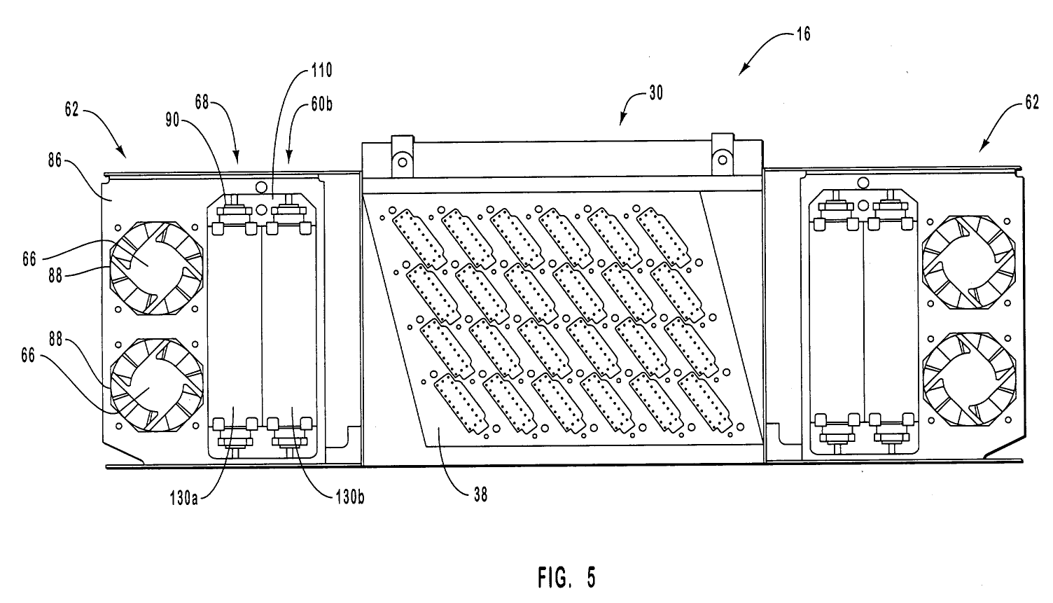

Referring to FIG. 5, supporting heating mechanisms 68a and 68b, and fans 66 are a connecting bracket 62 and a mounting bracket 64. In one embodiment, connecting bracket 62 is adapted to connect or couple heater assembly 60a to support structure 30, while mounting bracket 64 cooperates with connecting bracket 62 and receives or supports heating mechanisms 68a and 68b, and fans 66.

Connecting bracket 62 includes a connecting member 70 that cooperates with complementary structures upon support structure 30, while supports 74, 76 cooperate with mounting bracket 64. Each member 70 and support 74, 76 may be fixably or releasably coupled to respective structures or brackets through one or more fasteners, adhesives, metallic bonds, or other structures capable of performing the function of means for connecting one member to another member.

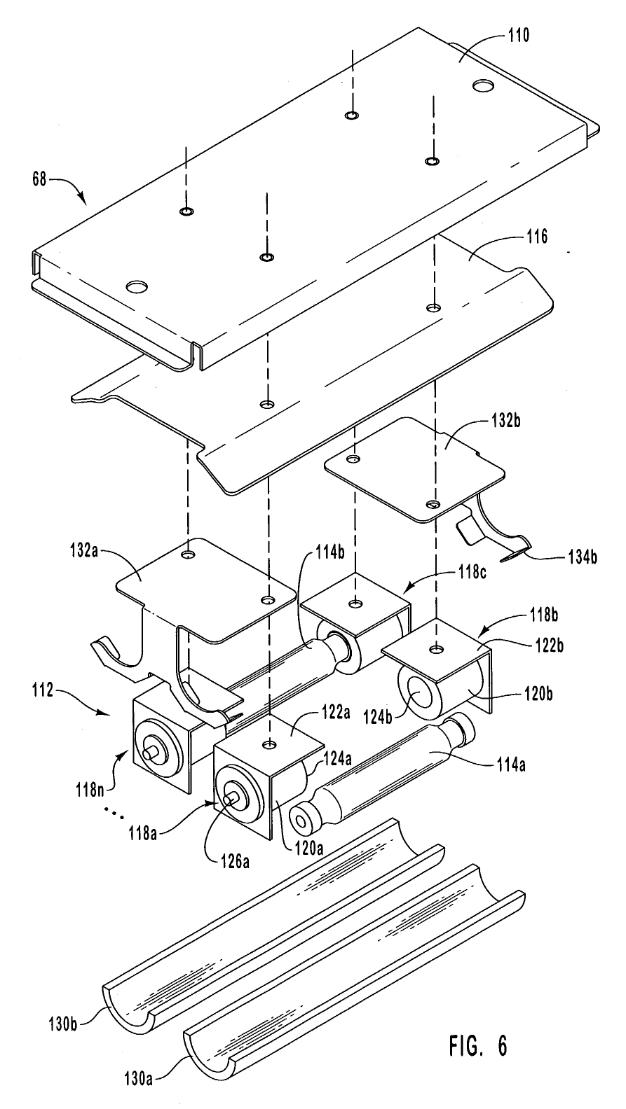

The mounting bracket 64 includes first and second mounting members 82 and 84 that may fixably or releasably couple to supports 74 and 76 respectively. The mounting bracket 64 includes a body 86 with one or more fan recesses 88 and one or more heating mechanism recesses 90. These recesses 88 and 90 may respectively receive one or more fans 66 and heating mechanisms 68a and 68b, as illustrated in FIG. 6. Any configuration of recesses 88 and 90 may be possible, whether one recess cooperates with one or more fans or heating mechanisms or vice versa.

Returning to FIG. 5, providing structural support to mounting bracket 64 are a central support 92 and one or more additional supports 94. Each support 92 and 94 aids with limiting torquing or bending of mounting bracket 64. Each support 92 and 94 may have various configurations, so long as support 92 and 94 aids with preventing torquing or bending of mounting bracket 64.

The following discussion will be directed to a single heating mechanism 68a. One skilled in the art, however, understands that the discussion also applies to heating mechanism 68b and the other heating mechanisms of the present invention.

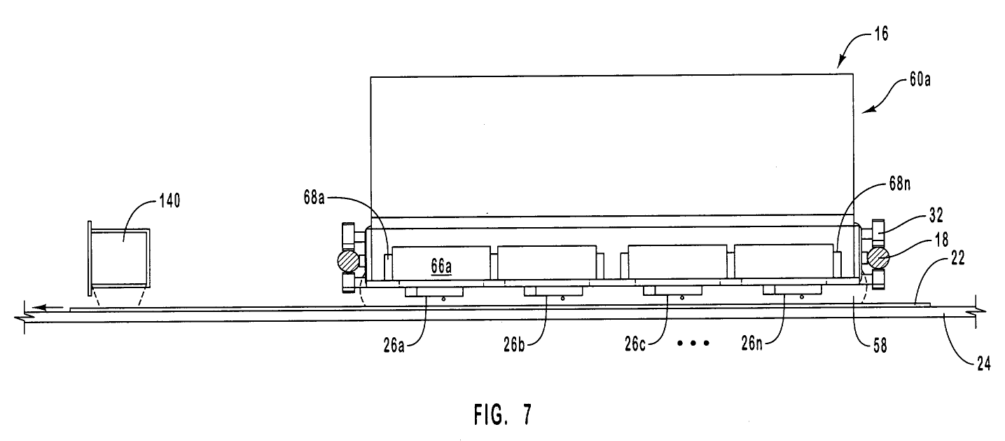

One embodiment of a heating mechanism 68 is illustrated in FIG. 7. Heating mechanism 68 includes a cover 110 that supports a radiation source 112 and other elements or components of heating mechanism 68. Cover 110 may be mounted to mounting bracket 64 (FIG. 6) so that radiation source 112 may emit radiation through heating mechanism recess 90 (FIG. 6). Mounting of cover 110 to mounting bracket 64 (FIG. 6) may be achieved through a variety of different structures capable of performing the function of means for connecting one member to another member. For instance, and not by way of limitation, cover 110 may be releasably or fixably connected to mounting bracket 64. Attachment of cover 110 to mounting bracket 64 may be achieved through one or more fasteners, adhesives, metallic bonds, indents and complementary recesses, complementary structures in both cover 110 and mounting bracket 64 that facilitates fixable or releasable coupling of cover 110 to mounting bracket 64, or other structures capable of performing the function of means for connecting one member to another member.

Radiation source 112 of heating mechanism 68 is configured to direct electromagnetic radiation toward the ink deposited upon printable medium 22 (FIG. 2). Radiation source 112 may have a variety of configurations and may direct different wavelengths of electromagnetic radiation toward the ink. In one embodiment illustrated in FIG. 7, radiation source 112 includes two halogen lamp 114a and 114b. Although two lamps are discussed herein, one or more lamps may be used to deliver the desired radiation.

Use of halogen lamp 114a and 114b provides a fast response period between turning radiation source 112 “on” and radiation source 112 generating the desired electromagnetic radiation, i.e., warming or heating up of radiation source 112. Similarly, halogen lamps 114a and 114b provide a fast response period between turning radiation source 112 “off” and ceasing delivery of electromagnetic radiation to the medium, i.e., cooling down the radiation source 112. The rapid response time between turning radiation source 112 “on” or “off” and achieving the resultant affect, i.e., delivering radiation or stopping delivery of radiation to the deposited ink may range from about 0.25 seconds to about 5 seconds. In another configuration, the rapid response time may range from about 0.1 seconds to about 30 seconds.

The wavelength of electromagnetic radiation generated by halogen lamps 114a and 114b is useful in drying ink deposited upon printable medium 22 (FIG. 2). The halogen lamps 114a and 114b create a wide spectrum of visible light. Additionally, halogen lamps 114a and 114b generate or output electromagnetic radiation of the IR spectrum. This IR spectrum for the radiation generated by halogen lamps 114a and 114b may range from about 0.76 μm to about 10 μm. Using this IR radiation, the radiation may penetrate one or more layers of deposited ink to dry the deposited ink. Optionally, the radiation may penetrate the ink to be incident upon printable medium 22 to heat printable medium 22 and aid with the drying of the deposited ink. Additionally, the electromagnetic radiation may fall upon platen 24 (FIG. 2) to evenly heat platen 24 and create a thermal mass that emits heat energy uniformly to printable medium 22 (FIG. 2).

In addition to creating IR radiation, the radiation generated by halogen lamps 114a and 114b has a wavelength spectrum with a high peak at shorter wavelengths of the IR spectrum. In one configuration, halogen lamps 114a and 114b produce electromagnetic radiation having a peak between about 760 nanometers and about 2300 nanometers. Again, the inclusion of this spectrum peak at shorter wavelengths of IR spectrum enables the radiation to penetrate the ink and be incident upon the printable medium to heat the printable medium and dry the deposited ink.

Although reference is made herein to use of halogen lamps as the radiation source, one skilled in the art may appreciate that various other types of radiation source and/or lamps may be used in conjunction with the present invention. For instance, and not by way of limitation, radiation source 112 may utilize one or more pressurized, horizontally or vertically mounted quartz halogen bulbs. In still another configuration, radiation source 112 may utilize one or more quartz lamps or heating elements to generate electromagnetic radiation that may penetrate one or more layer of deposited ink. Although it is desirable in one embodiment for the electromagnetic radiation to penetrate one or more layers of deposited ink and be incident upon the printable medium and/or the platen, radiation sources that generate radiation that partially penetrates one or more layer of deposited ink may be used as part of the present invention. Other types of radiation source 112 may include those that generate medium wavelength infrared radiation, long wavelength infrared radiation, combinations thereof, or other radiation sources that generate electromagnetic radiation capable of penetrating one or more layers of deposited ink, and optionally be incident upon the printable medium and/or the platen.

Output power levels of radiation source 112, and hence halogen lamps 114a and 114b may be varied. By varying the power output of radiation source 112, printing system 8 (FIG. 1) may deliver variable power levels of radiation to the print medium and the ink deposited thereupon. Printer device 10, therefore, may be used with a variety of different printable media, such as, but not limited to, temperature sensitive media.

Power output from radiation source 112 may be varied through use of a power controller, such as by varying one or more switches, buttons, phase angle dimmer controllers, or other devices for inputting an individual's selection to change the output power of radiation source 112. The controller, such as controller 52 with associated input devices (not shown) may change the output of the radiation source in response to manual changes to the controller or may automatically change the output of the radiation source in accordance with a defined program stored at one or more computers or other hardware components (not shown) local to print device 10 or remote from print device 10, while electrically communicating with print device 10. In one configuration the controller may initially cause radiation source 112 to initially exhibit a high output power level during start up of printing system 8 (FIG. 1), and subsequently cause radiation source 112 to exhibit a lower output power level during the printing process. By so doing, printing system 8 (FIG. 1) may be quickly prepared for the printing process.

The controllers may also control the period of time that radiation source irradiates the deposited ink, the printable medium, and/or the platen. For instance, the controllers may flash the radiation sources “on” and “off” as printable medium 22 is moved and the ink deposited thereupon. Alternatively, the flashing may be controlled as the radiation source is moved relative to the printable medium or the print heads relative to the printable medium. Flashing radiation sources “on” and “off” controls the level of irradiation of each ink drop deposited upon the printable medium.

In one configuration, when printing system 10 (FIG. 1) includes multiple heating mechanisms, one or more radiation sources may be flashed “on” and “off”, while optionally one or more other radiation sources may be maintained in an “on” state. Alternatively, all radiation sources may be flashed “on” and “off.” In one configuration, with the reverse also being an option, the radiation sources flashed “on” and “off” may be positioned in front of print heads 20a-20n (FIG. 2), in the direction of travel of printer head carriage 16, while the radiation sources that are maintained in the “on” state are positioned behind print heads 20, in the direction of travel of printer head carriage 16. The flashing radiation sources pre-warm the printable medium while radiation sources maintained in the “on” state during the printing process dry the deposited ink.

With respect to FIG. 2, when printer device 10 operates to deposit ink in a forward movement, indicated by Arrow A, one or more of the radiation sources associated with heater assembly 60a may be maintained in an “on” state, while the radiation sources associated with heater assembly 60b may be optionally flashed. Similarly, when printer device 10 operates to deposit ink in the direction indicated by Arrow A′ in FIG. 2, one or more of the radiation sources associated with heater assembly 60b may be maintained in an “on” state, while the radiation sources associated with heater assembly 60a may be optionally flashed.

Through partially drying deposited ink through a combination of flashing radiation sources “on” and “off” and/or maintaining radiation sources “on”, the present invention aids with reducing the occurrence of artifacts on printed images to produce colors resulting from a combination of the ink deposited by print heads 20a-20n (FIG. 2). By partially drying a first drop of ink using the heating mechanisms, a subsequent drop of ink does not merge with the first drop, but rather is disposed atop of the first drop. Since the first drop is partially dried, subsequent ink drops do not merge, but lie upon the first drop. By preventing merging of the ink drops, the present invention limits the potential for low quality print images resulting when two or more different color ink drops merge.

The potential for coalescence of adjacent ink drops is reduced through partially drying the deposited ink. Coalescence or the forming of an uneven layer of deposited ink occurs as a deposited ink drop slides from a deposited position to merge with an adjacent ink drop. By partially drying deposited ink with radiation source 112 in accordance with the present invention, the ink drop is prevented from sliding and the potential of coalescence reduced.

The use of radiation source 112 also increases print resolution of the images created upon a printable medium. For instance, partially drying the ink in accordance with the present invention partially shrinks the deposited ink, thereby reducing the surface area covered by the ink. In reducing the surface area covered by each deposited ink drop, the present invention enables a greater number of ink drops to be deposited upon the same printable medium. By increasing the number of ink drops capable of being deposited in an area of printable medium, the resolution of print images is increased.

Furthermore, applying focused electromagnetic radiation from radiation source 112 aids with affixing deposited ink to a heat-sensitive medium, such as, but not limited to, vinyl, plastics, synthetic materials, water-resistant materials, polyethylene, polypropylene, films, laminates, or other materials. In one example, ink deposited upon a vinyl medium typically attacks an interface layer formed on the medium and creates a a bond between the ink and the layer. Through directing electromagnetic radiation upon the ink and medium in accordance with the teachings contained herein, the deposited ink affixes or sticks to the medium to a higher degree than is currently the case because the radiation partially softens the medium to allow the ink to create a stronger bond with the medium.

The power output of radiation source 112 may range from about 100 watts to about 500 watts. In other configurations, the power output of radiation source 112 may be about 2400 watts, about 4000 watts, or any other wattage desired by those skilled in the art. Still in other configurations, radiation source 112 may have an output power greater at start-up of printing system 10 (FIG. 1) than during usage of printing system to reduce the start-up period before beginning a printing process. By so doing, printing system 10 may by quickly prepared for a printing process.

Returning to FIG. 7, cooperating with cover 110 is a reflector 116 that is adapted to direct electromagnetic radiation generated by radiation source 112 toward the printable medium and the ink deposited thereupon. The reflector 116 may be mounted to cover 110 using a means for connecting one member to another member, including, but not limited to, using brackets or other suitable connectors. The reflector 116 may have a parabolic, elliptic, or other geometric configuration in order to focus the radiation emitted by radiation source 112 toward the deposited inks. A parabolic reflector will reflect radiation in parallel, while an elliptical reflector delivers maximum intensity. Although discussion is made here of use of a parabolic or elliptic reflector, one skilled in the art may appreciate that various other configurations of reflector 116 may be used to direct radiation generated by radiation source 112 towards the ink deposited on the printable medium. For instance, reflector 116 may have any curvature and optionally cooperate with one or more mirrors, lenses, prisms, or other optical components that direct the radiation toward the printable medium.

As illustrated, reflector 116 may be formed as a single continuous piece that directs radiation from radiation source 112 having two halogen lamps 114a and 114b. Alternatively, reflector 116 may include multiple parts that are separately coupled or attached to cover 110. For example, in one possible embodiment, reflector 116 may include two symmetrical parts that are mounted on opposite sides of radiation source 112, that has one or more halogen lamps or other radiation sources, but are still capable of directing the radiation generated by radiation source 112 toward the printable medium. In another configuration, two or more parts may be used to reflect the radiation generated by radiation source 112, whether or not such part form a complete curved surface within cover 110.

Cover 110 supports one or more radiation source mounts 118a-118n. The illustrated configuration includes two radiation source mounts, however, the number of mounts will be based upon the number of lamps or other sources of radiation associated with radiation source 112. In this configuration, radiation source mounts 118a-118d are adapted to support radiation source 112 and maintain the same within a desired position such that the electromagnetic radiation generated by radiation source 112 is directed toward the printable medium and the ink deposited thereupon. The following discussion will be directed to radiation source mounts 118a and 118b, although a similar discussion may be made with respect to the other radiation source mounts that may form part of heating mechanisms 68a and 68b.

As illustrated, each radiation source mount 118a and 118b includes a receiver 120a and 120b, respectively. Additionally, each receiver 120a and 120b cooperates with a respective mounting member 122a and 122b. Each receiver 120a and 120b includes a hole 124a and 124b, respectively, which is adapted to cooperate with an end of a halogen lamp, such as halogen lamp 114a in this exemplary configuration. In this manner, receivers 120a and 120b support radiation source 112. The configuration of holes 122a and 122b is such that each is complementary to an end of radiation source 112. Therefore, receivers 120a and 120b and holes 124a and 124b may have various configurations so long as such configurations are complementary to radiation source 112.

Each receiver 120a and 120b includes an electrical contact, with only electrical contact 126a of receiver 120a being illustrated. Similar electrical contacts may be associated with the other receivers of the present invention. Each electrical contact is adapted to electrically connect radiation source 112 to a power source (not shown) that provides the electrical current and voltage to enable radiation source 112 to emit the desired radiation. Various manners are known by one skilled in the art to electrically connect the electrical contacts, the radiation sources, and the one or more power supplies.

Each mounting member 122a and 122b cooperates with a respective receiver 120a and 120b. In the illustrated configuration, receiver 120a engages with mounting member 122a through complementary threads, slip-fit connection, or other means for connecting one member to another member, so that receiver 120a is releasably connected to mounting member 122a. Similarly, receiver 120b engages with mounting member 122b so that receiver 120b is releasably connected to mounting member 122b.

To protect radiation source 112, each heating mechanisms 68a and 68b include protector members 130a and 130b, as may be seen in FIGS. 6 and 7. In the event that heating mechanisms 68a and 68b include one or more halogen lamps 114, heating mechanisms 68a and 68b may include one or more protector members, whether or not the number of protector members equals the number of halogen lamps or other sources of radiation associated with radiation source 112.

In the illustrative configuration, protector members 130a and 130b partially or complement surrounds radiation source 112. While protector members 130a and 130b prevent inadvertent contact of radiation source 112, protector members 130a and 130b allow the electromagnetic radiation generated by radiation source 112 to pass to the printable medium and the ink deposited thereupon. Optionally, each protector member may act as a lens and focus the electromagnetic radiation created by radiation source 112 toward the ink deposited upon the printable medium, while also preventing inadvertent contact with radiation source 112 by the operator of printing system 10 (FIG. 1).

Each protector member 130a and 130b may be fabricated from a variety of different materials so long as the material allows transmission or propagation of all or selected wavelengths of electromagnetic radiation created by radiation source 112 to the ink deposited upon the printable medium and can withstand the elevated temperatures associated with radiation source 112. For instance, each protector member 130a and 130b may be fabricated from a polymer material, a synthetic materials, a glass material, such as, but not limited to, quartz glass or tempered glass, a composite material, combinations thereof, or other materials capable of allow transmission or propagation of all or selected wavelengths of electromagnetic radiation created by radiation source 112, while having sufficient rigidity to prevent inadvertent contact of radiation source 112.

To support protector members 130a and 130b, heating mechanism 68 of FIG. 7 includes protector mounts 132a and 132b. The protector mounts 132a and 132b support protector members 130a and 130b and position the same relative to radiation source 112, as depicted in FIG. 6. As illustrated, each protector mount 132a and 132b is adapted to cooperate with cover 110 and/or reflector 116. More generally, each protector mount 132a and 132b may cooperate with one or more of the components and elements forming heating mechanism 68. Similarly, the other components and elements of heating mechanism 68 may be adapted to cooperate one with another and with one or more of protector mounts 132a and 132b.

Referring now to FIG. 8, depicted is a schematic representation of printer device 10. As described above, heating assembly 60a may partially or substantially completely dry the ink deposited upon printable medium 22. In the event that the ink is not completely dried by heating assembly 60a, printer device 10 may optionally include one or more secondary heating sources 140 that may aid with drying the ink deposited upon the printable medium. Following the partial drying by heating assembly 60a and/or heating assembly 60b (FIG. 2), the printable medium follows a drying path to one or more secondary heating sources 140, one shown in FIG. 8 and another shown in dotted lines in FIG. 1, which completes the drying process of the deposited ink. Once the ink is dried, the printable medium may be rolled upon a core 142.

The secondary heating sources 140 may have various configurations. For instance, but not by way of limitation, the secondary heating sources may be an air heating duct drying device or system, an IR drying device or system, a ribbon-type drying device or system, combinations thereof, or other device or system that is capable of drying ink deposited upon a printable medium. Further, the printer device may include one or more secondary heating sources and various positions along the drying path of the printable medium.

Embodiments of the present invention facilitate drying of deposited ink upon a printable medium, while reducing the potential for increasing the air temperature within the print zone of the printer device. Through use of directed electromagnetic radiation rather than generalized heating, the printer device and systems of the present invention may quickly dry deposited ink without degrading the print quality or damaging the printable medium.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A heater assembly for a printing system having a moveable print carriage supporting at least one print heat that deposits at least one ink droplet upon a medium, the heater assembly comprising at least one halogen lamp mounted to said print carriage.

2. The heater assembly as recited in claim 1, further comprising at least one reflector adapted to reflect radiation generated by said at least one halogen lamp.

3. The heater assembly as recited in claim 1, wherein said at least one halogen lamp has an activated state where said at least one halogen lamp generates electromagnetic radiation and a deactivated state where said at least one halogen lamp does not generate electromagnetic radiation.

4. The heater assembly as recited in claim 3, wherein said at least one halogen lamp changes from said deactivated state to said activated state within about 0.25 seconds to about 5 second following said at least one halogen lamp being triggered to said activated state.

5. The printing system as recited in claim 1, wherein said at least one halogen lamp generates radiation having a radiation spectrum with a peak value between about 760 nanometers and about 2300 nanometers.

6. The printing system as recited in claim 1, wherein said at least one halogen lamp generates radiation having a wavelength between about 0.76 μm to about 10 μm.

7. A heater assembly for a printing system having a moveable print carriage supporting at least one print head that deposits at least one ink drop upon a medium, the heater assembly comprising:
a mount cooperating with the print head carriage; and
at least one halogen lamp cooperating with said mount, said at least one halogen lamp adapted to generate electromagnetic radiation.

8. The heater assembly as recited in claim 7, further comprising at least one reflector adapted to reflect said radiation generated by said at least one halogen lamp.

9. The heater assembly as recited in claim 7, wherein said at least one halogen lamp generates infrared radiation.

10. The heater assembly as recited in claim 7, wherein said at least one halogen lamp generates radiation having a wavelength peak at a short wavelength of an infrared spectrum.

11. A heater assembly for a printing system having a moveable print head carriage supporting at least one print head that deposits at least one ink drop upon a medium, the heater assembly comprising:
at least one radiation source cooperating with the print head carriage, said at least one radiation source being adapted to generate radiation having sufficient wavelength to penetrate the ink drop to dry the ink drop; and
at least one reflector cooperating with said at least one radiation source.

12. The heater assembly as recited in claim 11, wherein said at least one radiation source generates infrared electromagnetic radiation.

13. The heater assembly as recited in claim 11, wherein said at least one radiation source generates radiation having a wavelength between about 0.76 μm to about 10 μm.

14. The heater assembly as recited in claim 11, wherein said at least one radiation source generates radiation having a wavelength peak at a short wavelength of an infrared spectrum.

15. The heater assembly as recited in claim 11, further comprising means for varying a power output of said at least one radiation source.

16. The heating assembly as recited in claim 15, wherein said means for varying said power output comprises a controller adapted to control a power output of said at least one radiation source.

17. The heating assembly as recited in claim 11, wherein said at least one radiation source comprises at least one halogen lamp.

18. The heating assembly as recited in claim 11, further comprising at least one fan.

19. The heating assembly as recited in claim 11, wherein said at least one radiation source is adapted to be sequentially activated to generate radiation and deactivated to cease generating radiation.

20. A printing system for printing ink onto a medium, the system comprising:
a print head for directing the ink onto the medium; and
means for drying the ink with radiation having a sufficient wavelength to penetrate the ink and be incident upon the medium below the ink, said means for drying moving with said print head.

21. The printing system as recited in claim 20, wherein said means for drying comprises at least one heater assembly adapted to generate said radiation.

22. The printing system as recited in claim 21, wherein said at least one heater assembly directs said radiation toward the medium before the ink is deposited thereupon.

23. The printing system as recited in claim 21, wherein said at least one heater assembly directs radiation toward the medium following depositing of the ink upon the medium.

24. The printing system as recited in claim 20, wherein said means for drying comprises:
at least one radiation source adapted to generate said radiation; and
at least one reflector cooperating with said at least one radiation source and being adapted to direct said radiation toward the medium.

25. A printing system for depositing ink droplets onto a medium, the system comprising:
a print head adapted to direct the ink droplets onto the medium; and
at least one heater assembly means moving with said print head, said at least one heater assembly being adapted to dry the ink droplet with radiation having a sufficient wavelength to penetrate the ink droplet and be incident upon the medium below the ink droplet.

26. The printing system as recited in claim 25, wherein said at least one heater assembly directs said radiation toward the medium before the ink droplet is deposited thereupon.

27. The printing system as recited in claim 25, wherein said at least one heater assembly directs radiation toward the medium following depositing of the ink droplet upon the medium.

28. The printing system as recited in claim 25, wherein said at least one heater assembly comprises:
at least one radiation source adapted to generate said radiation; and
at least one reflector cooperating with said at least one radiation source and being adapted to direct said radiation toward the medium.

29. A printing system for depositing ink upon a medium, the printing system comprising:
a print carriage adapted to move over the medium, said print head carriage supporting at least one print head adapted to direct ink onto the medium;
at least one first heater assembly moving with said print head carriage and being adapted to direct short-wavelength infrared radiation toward the medium preceding depositing of the ink upon the medium; and
at least one second heater assembly moving with said print head carriage and being adapted to direct infrared radiation toward the medium following depositing of the ink upon the medium.

30. The printing system as recited in claim 29, wherein at least one of said at least one first heater assembly and said at least one second heater assembly comprises:
at least one radiation source adapted to generate radiation; and
at least one reflector cooperating with said at least one radiation source and adapted to direct said radiation toward the ink.

31. The printing system as recited in claim 29, wherein said at least one radiation source generates short-wave radiation having a spectrum peak at a short-wavelength of an infrared spectrum.

32. The printing system as recited in claim 29, wherein said radiation has a wavelength between about 0.76 μm to about 2 μm.

33. The printing system as recited in claim 29, further comprising a platen adapted to cooperate with the medium, wherein said platen is adapted to act as a thermal mass.

34. The printing system as recited in claim 33, wherein at least one of said at least one first heater assembly and said at least one second heater assembly is adapted to uniformly irradiate said platen, wherein said platen uniformly heats the medium.

35. A method for drying ink deposited upon a medium, said method comprising:
depositing ink upon the medium; and
moving at least one halogen lamp over said ink to allow said at least one halogen lamp to deliver electromagnetic radiation to said ink to dry said ink.

36. The method as recited in claim 35, further comprising changing a state of said at least one halogen lamp between an activated state and a deactivated state as said at least one halogen lamp moves over said ink.

37. The method as recited in claim 35, further comprising uniformly irradiating a platen upon which is placed the medium.

38. The method as recited in claim 37, further comprising emitting radiation from said platen to said medium, said radiation aiding with drying said ink deposited upon the medium.

39. The method as recited in claim 35, further comprising irradiating the medium before depositing the ink, wherein irradiating the medium increases the temperature of the medium to dry said ink.

40. The method as recited in claim 35, further comprising drying at least one of said ink and the medium following delivery of said electromagnetic radiation.

41. The method as recited in claim 40, wherein a secondary heating source dries said ink.

42. The method as recited in claim 35, further comprising moving said at least one halogen lamp beyond a peripheral edge of the medium.
